(19) United States
(12) Patent Application Publication
(10) Pub. No.: US 2009/0081351 A1
(43) Pub. Date: Mar. 26, 2009

(54) Method for supplementing an aqueous liquid composition with calcium

(75) Inventors: Michel Mellema, 3133 At Vlaardingen (NL); Enrique Omar Salces, Buenos Aires (AR)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/150,023

(22) Filed: Apr. 24, 2008

(30) Foreign Application Priority Data
Apr. 27, 2007 (EP) EP07107091
Jun. 5, 2007 (EP) EP07109592

(51) Int. Cl. A23L 1/304; A23L 2/38

(52) U.S. Cl. 426/598; 426/648

(57) ABSTRACT

A method of producing an edible aqueous liquid composition that has been supplemented with at least 2 mmole calcium per litre, a soy drink that can be obtained by the present method and a reconstitutable powder that can be reconstituted to yield such a soy drink are also provided.

### TECHNICAL FIELD OF THE INVENTION

The present invention relates to a method for supplementing an edible aqueous liquid composition with calcium. More particularly, the present invention provides a method of preparing an aqueous liquid composition that has been fortified with bio-available calcium and that does not suffer from calcium-related off-taste or from sedimentation of calcium salt.

### BACKGROUND OF THE INVENTION

From a nutritional perspective it is desirable to add calcium to foodstuffs and beverages or to provide nutritional supplements containing high levels of calcium. In order to ensure that calcium is sufficiently absorbed it is generally preferred to incorporate calcium in the form of a bio-available salt.

It has been found that if the use of water-soluble calcium salts in water-containing, especially water-continuous edible products, is accompanied by an objectionable off-taste. This problem may be overcome by using a water-insoluble calcium salt. However, since these calcium salts are water-insoluble, they tend to precipitate rapidly during and after product manufacture. The resulting sediment adversely affects consumer acceptance of these products. Furthermore, if the product is not vigorously shaken before use to redisperse the sediment, at best only a part of the calcium content of the product will be consumed.

Accordingly, there is a need for a method that can suitably be used to produce fortified edible aqueous liquid compositions having a high content of bio-available calcium, that do not give rise to off-taste and that do not sediment during storage.

It is known in the art to produce an edible aqueous liquid containing bio-available calcium that does not give rise to sedimentation during storage. U.S. Pat. No. 6,811,800 describes a process for the preparation of calcium fortified soy milk, said process comprising the addition of a meta-stable concentrated soluble calcium solution. The concentrated soluble calcium solution is prepared from the following starting materials:

| | |
|---|---|
| Calcium hydroxide | 7.84 wt. % |
| Citric acid | 7.32 wt. % |
| Malic acid | 7.50 wt. % |
| Water | 77.24 wt. % |

The meta-stable calcium solution is prepared by dispersing the calcium hydroxide in 90% of the water at 3° C. and adding a dry blend of the citric and malic acids as well as the remaining water, followed by mixing until a clear solution is formed. The product is said to achieve high levels of soluble calcium and product stability without requiring an added stabiliser or chelating agent. The method described in U.S. Pat. No. 6,811,800 has several advantages. The method starts from a slurry which requires continuous mixing during addition of the acids. Mixing must be vigorous in order to prevent formation of, for instance, insoluble calcium citrate (Ca₃(C₆H₅O₇)₂). In addition, the method described in the US patent requires cooling to prevent premature formation of insoluble calcium salts.

WO 02/069743 describes a method for producing a calcium fortified beverage, comprising:
a) blending an aqueous solution of a calcium containing base and an acid to form a blended acid/base solution;
b) retaining the blended acid/base solution in an in-line reaction tube for a controlled amount of time sufficient to produce a calcium salt solution and to avoid precipitation of the calcium salt; and
c) continuously adding the calcium salt solution from the in-line reaction tube to a beverage, thereby producing a calcium fortified beverage.

According to the international patent application the aforementioned method can suitably be used to control the relative proportions of mono-, di-, and tri-valent calcium citrate. It is asserted that there is a natural transformation tendency from low-valent calcium citrate to high valent calcium citrate which is the most stable form and the least soluble form. The method described in the international patent application is said to avoid the production of tri-valent calcium citrate to effectively reduce the presence of precipitating salts.

An important drawback of the method described in WO 02/069743 is that it requires sophisticated equipment and that it can only be operated in a continuous fashion. In addition, the process described in the WO 02/069743 is very difficult to control as the time span between the production of a calcium salt solution and the start of calcium salt precipitation very short. Finally, the process described in the international patent application is not suitable for producing beverages containing high levels of calcium as the calcium salt will precipitate from these beverages over time.

Example 3 of international patent application WO 2007/098092, which was published after the priority date of the present application, describes the preparation of a ready-to-drink breakfast smoothie. Ingredients used in the preparation of this product include soy protein isolate, citric acid, malic acid, lactic acid, calcium hydroxide and pectin. Applicant has reproduced Example 3 of WO 2007/098092 and found that the breakfast smoothie described in this Example exhibits very limited storage stability.

### SUMMARY OF THE INVENTION

The inventors have developed a method for preparing an aqueous liquid composition that has been fortified with bio-available calcium which method does not suffer from the drawbacks of the aforementioned prior art methods. In the method of the present invention a water insoluble calcium carbonate salt is added to an acidic aqueous liquid and allowed to react under decarboxylation to form water soluble calcium salt(s), thus creating a meta-stable calcium solution, following which sedimentation of water-insoluble calcium salt is prevented by adding soy protein and, if necessary, by increasing the pH.

Thus, the present invention provides a method for producing an edible aqueous liquid composition that has been supplemented with calcium, said method comprising the successive steps of:
providing an acidic aqueous liquid having a pH in the range of 1.0-5.0 and containing dissolved acid that is capable of forming a water-insoluble salt with calcium;
adding to the acidic aqueous liquid a solid water-insoluble calcium carbonate salt;
allowing the calcium carbonate to decarboxylate until all calcium is dissolved; and
stabilising the meta-stable solution against sedimentation of calcium salt by adding soy protein to said meta-stable solution and, if the pH of said meta-stable solution is less than 3.2, by increasing the pH of said solution to a pH of more than 3.2.

The method of the present invention offers the advantage that since it starts from a solution of acid and since the calcium carbonate reacts very swiftly, it is quite easy to control the decarboxylation reaction. Furthermore, the present process offers the advantage that the meta-stable calcium solution is relatively stable. Thus, it is not necessary to conduct the reaction at reduced temperatures or to hold the meta-stable solution at a low temperature until it is stabilised through the addition of soy protein and pH increase. As a matter of fact, in the present method, after a clear meta-stable calcium solution has formed, said solution can be kept at ambient conditions for a few hours without any sedimentation occurring.

### DETAILED DESCRIPTION OF THE INVENTION

Accordingly, one aspect of the invention relates to a method of producing an edible aqueous liquid composition that has been supplemented with at least 2 mmole, preferably at least 7 mmole, more preferably at least 10 mmole calcium per litre, said method comprising the successive steps of:
a. providing an acidic aqueous liquid having a pH in the range of 1.0-5.0, preferably of 1.4-3.5 and containing dissolved acid that is capable of forming a water-insoluble salt with calcium;
b. adding to the acidic aqueous liquid a solid water-insoluble calcium carbonate salt;
c. allowing the calcium carbonate to decarboxylate until all calcium is dissolved; and
d. stabilising the meta-stable solution against sedimentation of calcium salt by adding soy protein to said meta-stable solution and, if the pH of said meta-stable solution is less than 3.2, by increasing the pH of said solution to a pH of more than 3.2.

The term “edible aqueous liquid composition” as used herein encompasses liquid foodstuffs, liquid nutritional compositions, liquid pharmaceutical compositions as well as beverages. Examples of liquid foodstuffs that are encompassed by the term “edible aqueous liquid composition” include dressings, pourable yogurt, soups, sauces etc. According to a preferred embodiment, the “edible aqueous liquid composition” is a beverage, especially a proteinaceous beverage containing at least 0.1 wt. %, preferably at least 0.3 wt. %, more preferably at least 0.4 wt. % of protein.

The term “soy protein” as used herein encompasses intact as well as hydrolysed soy protein. The soy protein may be undenatured or denatured. It is also within the scope of the present invention to employ a blend of denatured and undenatured soy protein and/or of hydrolysed or non-hydrolysed soy.

In step c) of the present method the water-insoluble calcium carbonate salt is converted into dissolved calcium salt. Here by “dissolved calcium salts” it is meant that the calcium salt is present in a form that does not scatter light and that does not sediment. This is achieved in case the calcium salt is dissolved at a molecular level or if it present in the form of extremely small particles, i.e. particles having a diameter of less than 50 nm, more preferably of less than 5 nm. Most preferably, the dissolved calcium salt is molecularly dissolved.

The present method comprises the addition of solid water-insoluble calcium carbonate salts. In accordance with the present invention water-insoluble calcium carbonate is added in an amount that exceeds the maximum solubility of the carbonate salt in the aqueous liquid to which it is are added. According to a preferred embodiment, water-insoluble calcium carbonate salt is added in an amount that, under the conditions employed during the addition, exceeds the solubility of the salt in the aqueous liquid to which it is added by at least 10%, preferably by at least 25%. Here the solubility of the water-insoluble carbonate salt refers to the instant solubility of said carbonate salt upon addition.

Typically, the calcium carbonate salt employed in accordance with the present invention has a solubility in distilled water of 25° C. and pH 7 of less than 3 g/l, preferably of less than 1 g/l, and/or a degree of ionisation at 0.03 mol/l and pH 4.5 of less than 95%, preferably of less than 70%. Most preferably, the calcium carbonate salt meets both the solubility and the ionisation criterion. Here the degree of ionisaton refers to the molar fraction of the carbonate salt that is present in dissociated form.

The acidic aqueous liquid of step a) typically contains at least 5 mmole/l of the acid. Even more preferably, the concentration of acid is within the range of 20-300 mmole/l. The acid employed in the present method is suitably selected from the group consisting of citric acid, tartaric acid, malic acid, phosphoric acid and combinations thereof. Even more preferably, the acid is an organic acid selected from the group consisting of citric acid, tartaric acid, malic acid and combinations thereof. Most preferably, the organic acid is citric acid.

In accordance with a preferred embodiment of the present method, the solid water-insoluble calcium carbonate salt is added to the acidic aqueous liquid in an amount of at least 1 mmole/l. More preferably, the solid water-insoluble calcium carbonate salt is added in an amount of at least 5 mmole/l, most preferably of at least 10 mmole/l. Typically, the amount of insoluble calcium carbonate salt that is added to the acidic aqueous liquid does not exceed 250 mmole/l, most preferably it does not exceed 200 mmole/l.

Typically, in the present method, the water-insoluble calcium carbonate salt is added to the acidic aqueous liquid in a molar amount that represents 10-150% of the molar amount of acid that is contained in said acidic aqueous liquid. More preferably, the latter percentage is within the range of 20-100%.

The reaction rate between the calcium carbonate and the acid is determined by a number of factors including the size of the salt particles. According to a preferred embodiment, the calcium carbonate salt has a mass weighed average particle size of 1-100 μm, preferably of 2-60 μm.

In order to stabilise the meta-stable calcium solution, soy protein is advantageously added to the meta-stable calcium solution in an amount of at least 1 g/l, more preferably of at least 3 g/l. Typically, the amount of soy protein employed does not exceed 100 g/l. It should be understood that in accordance with the present invention the addition of the soy protein is achieved by combining the meta-stable calcium solution with a composition containing the soy protein. Thus, the present invention also encompasses a method in which addition of the soy protein is achieved by introducing the meta-stable solution into a soy protein containing liquid.

The addition of the soy protein and the optional pH increase during step d), typically are accompanied by a reduction in calcium content. Accordingly, in a preferred embodiment, the calcium content of the meta-stable solution is at least 1.05, more preferably at least 1.1 times higher than the calcium content of the edible aqueous liquid composition.

Although the inventors do not wish to be bound by theory it is believed that the addition of soy protein to the meta-stable solution stabilises the dissolved calcium salt in that charged groups of the biopolymer somehow complex calcium cations. As a result, calcium is kept in suspension due to its association to said biopolymer.

If necessary, the meta-stable clear solution is stabilised by increasing the pH of the solution to more than 3.2. According to a preferred embodiment, said solution is stabilised in step d) of the present method by increasing the pH to more than 3.2, most preferably to more than least 3.4. According to another preferred embodiment, in step d) the pH is increased by at least 0.3 pH units, most preferably by at least 0.5 pH units.

During the execution of steps a) to c), additional acid may be added. In addition, acid or lye may be added to adjust the pH. Preferably, during steps a) to c) of the present method, pH is maintained within the range of 1.0-4.5. Most preferably, pH is maintained within the range of 1.4-3.5.

Steps a) to c) of the present method are typically carried out at a temperature below 90° C., preferably below 70° C. Usually, the temperature employed during these steps exceeds 0° C., preferably it exceeds 6° C.

As mentioned herein before, the meta-stable calcium solution obtained in the present is relatively stable. However, said meta-stable solution will start forming a calcium salt sediment after some time. Typically, the meta-stable calcium solution of the present method is characterised in that sedimentation of calcium salt will occur if the solution is kept under quiescent conditions at a temperature of 20° C. for 24 hours. According to a preferred embodiment, sedimentation will occur under these conditions not later than after 12 hours.

According to another preferred embodiment of the present method fruit solids are added together with or after the addition of the biopolymer. Typically, fruit solids are added in an amount of at least 0.5 g/l, preferably of 5-50 g/l.

The inventors have observed that addition of certain polysaccharides to the meta-stable calcium solution serves to further stabilise the solution. According to a particularly preferred embodiment, at least 0.1 g/l of a polysaccharide selected from the group consisting of pectin, carrageenan, alginate, carboxymethyl cellulose, xanthan, gellan gum and combinations thereof is added to the meta-stable calcium solution. More preferably 0.2-30 g/l of said polysaccharide is added.

The present invention offers the advantage that it enables the preparation of an edible aqueous liquid composition that will not form calcium salt sediment during storage.

Hence, in accordance with a particularly preferred embodiment, the edible aqueous liquid composition obtained in the present method will not form a calcium salt sediment when stored at 20° C. under quiescent conditions for at least 3 months, or even when stored under these conditions for at least 6 months.

According to yet another advantageous embodiment, the present method yields a soy drink having a pH of 3.2-8.0, a soy protein content of 1-50 g/l and a calcium content of 2-40 mmole/l.

Another aspect of the present invention relates to a soy drink having a pH of 3.2-8.0, said soy drink comprising:
1-50 g/l of soy protein;
2-40 mmole/l of calcium;
1-60 mmole/l of an acid selected from the group consisting of citric acid, tartaric acid, malic acid, phosphoric acid and combinations thereof; and
at least 50 wt. %, preferably at least 80 wt. % of water;
   wherein the molar ratio of calcium to acid is within the range of 1:35 to 1.5:1 and wherein the soy drink is characterised in that it will not form a calcium salt sediment when stored at 20° C. under quiescent conditions for at least 3 months, or even for at least 6 months.

The above mentioned soy drink does not exhibit a calcium-linked off-taste and does not form a calcium salt sediment upon storage. Furthermore, the calcium in this soy drink is readily absorbed. The distinguishing features of the present soy drink reside in the specific levels in which calcium and acid are present, the amount of soy protein present and the pH of the beverage.

According to a particularly preferred embodiment, the acid contained in the soy drink is an organic acid, especially citric acid.

In accordance with another preferred embodiment, the soy drink contains at least 0.1 g/l, more preferably 0.2-30 g/l of a polysaccharide selected from the group consisting of pectin, carrageenan, alginate, carboxymethyl cellulose, xanthan, gellan gum and combinations thereof.

The benefits of the present invention are particularly pronounced in mildly acidic soy drinks. Hence, in accordance with a preferred embodiment, the soy drink has a pH in the range of 3.2-8.0.

The inventors have discovered that the stability of the calcium fortified edible aqueous liquid composition of the present invention is retained even if said composition is dried to a powder and reconstituted again with an aqueous liquid. Hence, another aspect of the invention relates to a reconstitutable powder containing:
at least 0.04, preferably 0.2-1.6 mmole of calcium per gram of powder;
at least 0.02, preferably 0.1-2.0 mmole of acid per gram of powder, said acid being selected from the group consisting of citric acid, tartaric acid, malic acid, phosphoric acid and combinations thereof;
at least 20 mg, preferably 120-500 mg of soy protein per gram of powder; and
less than 10 wt. %, preferably less than 5 wt. % of water; said reconstitutable powder further being characterised in that 25 grams of the powder can be reconstituted with 1 kg of water to yield an edible aqueous liquid that will not form a calcium salt sediment when stored at 20° C. under quiescent conditions for at least 3 months, or even for at least 6 months.

The reconstitutable powder of the present invention is advantageously packaged in sealed sachets that protect the powder against moisture. Preferably, each sachet contains 10-50 grams of the powder. A plurality of sachets containing the reconstitutable powder of the present invention is suitably packaged in a single container (e.g. a box), said container carrying instructions to dissolve the contents of a single sachet in 100-250 ml of an aqueous liquid.

According to a particularly preferred embodiment, the reconstitutable powder contains 0.1-1.0 mmole of citric acid per gram of powder.

The reconstitutable powder of the present invention advantageously contains 1-50 wt. %, more preferably 2-10 wt. % of a polysaccharide selected from the group consisting of pectin, carrageenan, alginate, carboxymethyl cellulose, xanthan, gellan gum and combinations thereof.

A further aspect of the present invention relates to a method of preparing a reconstitutable powder that has been supplemented with calcium, said method comprising preparing a supplemented aqueous liquid composition by means of the method defined herein before, followed by drying the edible aqueous liquid composition obtained by said method. In order to dry the aqueous liquid composition use can be made of any drying technique known in the art, such as spray drying, drum drying, freeze drying etc. Preferably, the drying of the edible aqueous liquid composition comprises spray drying and/or freeze drying. Most preferably, the method employs spray drying.

According to yet another advantageous embodiment, the present method yields a reconstitutable powder as defined herein before.

The invention is further illustrated by means of the following examples.

### EXAMPLES

### Example 1

A soy-based beverage was produced on the basis of the recipe described in Table 1.

TABLE 1

| | Wt. % |
|---|---|
| Soy protein isolate | 1.0 |
| HM pectin | 0.3 |
| Sucrose | 3 |
| Sucralose | 0.015 |
| Acesulfame-K | 0.01 |
| Maltodextrin | 2.0 |
| Fruit juice Concentrated 65°Brix | 2 |
| Citric Acid | 0.2 |
| Acid calcium base | 70 |
| Water | Remainder |

The soy beverage was prepared by dissolving of the soy protein isolate in water (4 wt. % protein) having a temperature of 80-85° C., keeping the solution at that temperature for 10 minutes and subsequently cooling it down to 5-8° C.

A premix of the pectin and the sugar (1:5 (w/w)) was dissolved in water (3 wt. % pectin) having a temperature of 60-70° C. The mixture was stirred until all pectin had dissolved. Next, the solution was cooled to room temperature, following which the pectin solution was added to the soy protein isolate solution. The mixture was agitated with sufficient mechanical force to enable very good interaction between the components.

Next, the sugar, sucralose, acesulfame-k and maltodextrin were added under stirring, followed by the acid calcium base, which was also added under stirring. The acid calcium base had the composition described in Table 2 and had been prepared by dissolving the citric acid in water having a temperature of 20° C., followed by the addition of the calcium carbonate. After about 5 minutes a transparent meta-stable acid calcium solution was obtained that was immediately added to the soy protein/pectin solution.

TABLE 2

| | Wt. % |
|---|---|
| Citric Acid | 0.57 |
| Calcium carbonate¹ | 0.23 |
| Water | 99.20 |

¹HuberCAL ™ Grade 850 - Median Particle Size 4 microns - J. M. Huber Corp.

Subsequently, the fruit juice was introduced under stirring after which citric acid was added to adjust the pH of the beverage to 3.8-4.3. The beverage product was sterilised in a tubular UHT system and subsequently homogenised at 220-230 bar. The product was filled in sterilised 1 litre glass bottles under aseptic conditions (laminar flow) and stored at 20° C.

### Example 2

Another soy-based beverage was produced on the basis of the recipe described in Table 3.

TABLE 3

| | Wt. % |
|---|---|
| Soy bean extract | 15 |
| HM pectin | 0.3 |
| Sucrose | 7 |
| Sucralose | 0.005 |
| Maltodextrin | 0.5 |
| Fruit juice Concentrated 65°Brix | 0.8 |
| Citric Acid | 0.2 |
| Acid calcium base | 20 |
| Water | Remainder |

The soy bean extract was prepared by adding dehulled soy beans to water (1:5 (w/w)) having a temperature of 85-90° C. and a pH of 7.0-8.2. The resulting mixture is milled and held for at least 30 seconds to inactivate enzymes and to improve extraction of soy protein. Next, the solid residue was separated from the slurry by centrifugation. The resulting soy bean extract was heat treated to inactivate trypsin inhibitors and was cooled to 5-8° C.

A premix of the pectin and the sugar (1:5 (w/w)) was dissolved in water (3 wt. % pectin) having a temperature of 20° C. The mixture was stirred until all pectin had dispersed. Next, the pectin solution was added to the soy bean extract. The resulting mixture was agitated with sufficient mechanical force to enable very good interaction between the components.

Next, the sugar, sucralose and maltodextrin were added under stirring, followed by the acid calcium base, which was also added under stirring. The acid calcium base had the composition described in Table 4 and had been prepared by dissolving the citric acid in water having a temperature of 20° C., followed by the addition of the calcium carbonate. After about 5 minutes a transparent meta-stable acid calcium solution was obtained that was immediately added to the soy protein/pectin solution.

TABLE 4

| | Wt. % |
|---|---|
| Citric Acid | 2.00 |
| Calcium carbonate¹ | 0.80 |
| Water | 97.20 |

¹HuberCAL ™ Grade 850 - Median Particle Size 4 microns - J. M. Huber Corp.

Subsequently, the fruit juice was introduced under stirring after which citric acid was added to adjust the pH of the beverage to 3.8-4.3. The beverage product was sterilised in a tubular UHT system and subsequently homogenised at 220-230 bar. The product was filled in sterilised 1 litre glass bottles under aseptic conditions (laminar flow) and stored at 20° C.

### Example 3

A further soy-based beverage was produced on the basis of the recipe described in Table 5.

TABLE 5

| | Wt. % |
|---|---|
| Soy bean extract | 60 |
| Sucrose | 3 |
| Acid calcium base | 30 |
| Carrageenan | 0.04 |
| Water | Remainder |

The soy bean extract and the acid calcium base were produced in the same way as described in Example 2. The acid calcium base was slowly added to the soy bean extract under stirring and additional water was added. Next, a premix of sugar and carrageenan was added to the liquid blend. Subsequently, the liquid blend was sterilised, homogenised, packaged and stored as described in Example 2.

### Example 4

Example 2 was repeated, except that this time the soy-based beverage was produced on the basis of the recipe described in Table 6.

TABLE 6

| | Wt. % |
|---|---|
| Soy bean extract | 75 |
| Sucralose | 0.01 |
| Acid calcium base | 20 |
| Carrageenan | 0.04 |
| maltodextrin | 0.5 |
| Water | Remainder |

The soy bean extract and the acid calcium base were produced in the same way as described in Example 2. The acid calcium base was slowly added to the soy bean extract under stirring and additional water was added. Next, a premix of maltodextrin, sucralose and carrageenan was added to the liquid blend. Subsequently, the liquid blend was sterilised, homogenised, packaged and stored as described in Example 2.

### Example 5

Another soy-based beverage was produced on the basis of the recipe described in Table 7.

TABLE 7

| | Wt. % |
|---|---|
| Soy bean extract | 15 |
| HM pectin | 0.3 |
| Sucrose | 7 |
| Sucralose | 0.005 |
| Maltodextrin | 0.5 |
| Fruit juice Concentrated 65°Brix | 0.8 |
| Citric Acid | 0.2 |
| Sodium hexamethaphosphate | 0.05 |
| Acid calcium base | 20 |
| Water | Remainder |

The soy bean extract was prepared by adding soy beans to water (1:5 (w/w) having a temperature of 85-90° C. and a pH of 7.0-8.2. The resulting mixture is milled and held for at least 30 seconds to inactivate enzymes and to improve extraction of soy protein. Next, the solid residue was separated from the slurry by centrifugation. The resulting soy bean extract was heat treated to inactivate trypsin inhibitors and was cooled to 5-8° C.

A premix of the pectin and sugar (1:5 (w/w)) was dissolved in water (3 wt. % pectin) having a temperature of 20° C. The mixture was stirred until all pectin had dispersed. Next, the pectin solution was added to the soy bean extract. The resulting mixture was agitated with sufficient mechanical force to enable very good interaction between the components.

Next, the remaining sugar, sucralose, maltodextrin and sodium hexamethaphosphate were added under stirring, followed by the acid calcium base, which was also added under stirring. The acid calcium base had the composition described in Table 8 and had been prepared by dissolving the citric and malic acids in water having a temperature of 20° C., followed by the addition of the calcium carbonate. After about 5 minutes a transparent meta-stable acid calcium solution was obtained that was immediately added to the soy protein/pectin solution.

TABLE 8

| | Wt. % |
|---|---|
| Citric Acid | 1.50 |
| Malic Acid | 0.50 |
| Calcium carbonate¹ | 0.80 |
| Water | 97.20 |

¹HuberCAL ™ Grade 850 - Median Particle Size 4 μm - J. M. Huber Corp.

Subsequently, the fruit juice was introduced under stirring after which citric acid was added to adjust the pH of the beverage to 3.8-4.3. The beverage product was sterilised in a tubular UHT system and subsequently homogenised at 220-230 bar. The product was filled in sterilised 1 litre glass bottles under aseptic conditions (laminar flow) and stored at 20° C.

### Example 6

During a storage period of 18 weeks, the beverages described in Examples 1-5 were analysed and evaluated by a test panel. The following analyses and evaluations were performed:

### Redispersibility of Sediment

To determine the redispersibility of sediment a small portion of the product was taken out of the upper part of the bottle using a pipette. With the rest of the content the bottle was shaken rigorously two times. A visual estimation was made of how much of the sediment disappeared after shaking. This was done for samples stored for up to 18 weeks. Mineral sediment is typically poorly redispersible compared to protein sediment. Furthermore, unlike protein sediment, mineral sediment has a clear white colour.

### Concentration of Calcium in the Sediment

Samples were taken from the top layer of the bottle after 1 day, 3, 6, 12 and 16 weeks of storage. The amounts of calcium was measured by Inductively Coupled Plasma Emission Spectrometry. For this the samples are extracted in dilute hydrochloric acid and the solution is sprayed into the inductively coupled plasma of a plasma emission spectrometer, after which the emission is measured for calcium at 31.933 nm. The calcium content is determined by comparison with a blank and standard solution of calcium in diluted hydrochloric acid (direct method of determination). The amount of sedimented calcium was calculated with the formula (the amounts being calculated by multiplying the measured calcium concentration in with the total volume of sample or supernatant):

% of Ca in sediment=((amount of Ca in total sample−amount of Ca in supernatant)/amount of Ca in total sample)×100%

### Taste Panelling

To judge the samples on their taste a test was done with a panel of 15 panel members specifically trained on mineral-fortified soy/fruit beverages. Rigorous shaking to remove any sediment was applied before tasting. The samples were compared with reference products that were prepared in exactly the same fashion, except that water was added instead of the acid calcium base.

### Results

| | | | Colour of | % of total Ca | Panel |
|---|---|---|---|---|---|
| Ex. | Sediment properties | | sediment | in sediment | result |
| 1 | <1 vol. % | completely | Cream colour | <1 wt. % | Preferred |
| | | redispersible | without any | | |
| | | | white sediment | | |
| 2 | <1 vol. % | completely | Cream colour | <1 wt. % | Preferred |
| | | redispersible | without any | | |
| | | | white sediment | | |
| 3 | <1 vol. % | completely | Cream colour | <1 wt. % | No |
| | | redispersible | without any | | significant |
| | | | white sediment | | difference |
| 4 | <1 vol. % | completely | Cream colour | <1 wt. % | No |
| | | redispersible | without any | | significant |
| | | | white sediment | | difference |
| 5 | <1 vol. % | completely | Cream colour | <1 wt. % | No |
| | | redispersible | without any | | significant |
| | | | white sediment | | difference |

### Example 7

A reconstitutable powder was produced by spray drying the composition described in Table 11.

TABLE 11
Composition of feed to spray drier

Wt. %

Soy Protein base

| | |
|---|---|
| HM pectin | 1.2 |
| Maltodextrin | 3.5 |
| Demi water | 22.1 |
| Soybean extract (6.5% protein, 17% solids) | 59.0 |

Acid calcium solution

| | |
|---|---|
| Calcium carbonate | 0.6 |
| Citric acid | 1.2 |
| Malic acid | 0.4 |
| Demi water | 12.0 |

Pectin and maltodextrin were added to the soy base and water slowly while stirring. After all the pectin and maltodextrin had been added, the resulting mixture was stirred under high shear for 30 minutes.

In parallel, the acid calcium solution was prepared by dissolving the citric and malic acids in water having a temperature of 20° C., followed by the addition of the calcium carbonate. After about 5 minutes a transparent meta-stable acid calcium solution was obtained that was immediately added to the soy protein base. The blend of these two bases was mixed for a few minutes under high shear. This was followed by an one-stage homogenisation at 150 Bar.

After this the solution was spray-dried. Inlet temperature was 180° C., outlet 80° C. Nozzle pressure was 3.5 bar. Feed flow rate was 15 kg/h. A powder was obtained with moisture content of approx. 4% and a protein content of approx. 22 wt. %. The composition of the spray dried powder is described in Table 12.

TABLE 12
Composition of powder

| | Wt. % |
|---|---|
| HM pectin | 6.8 |
| Maltodextrin | 20 |
| Water | 3.4 |
| Solid from soy bean extract | 57.3 |
| Calcium carbonate | 3.4 |
| Citric acid | 6.8 |
| Malic acid | 2.3 |

### Example 8

The spray dried powder of example 7 was made into a soy/fruit drink using the recipe of Table 13:

TABLE 13

| | Wt. % |
|---|---|
| Powder of Example 7 | 2.50 |
| Sucrose | 7 |
| Sucralose | 0.005 |
| Fruit juice Concentrated 65°Brix | 0.8 |
| Citric Acid | 0.2 |
| Sodium hexamethaphosphate | 0.05 |
| Water | Remainder |

The soy beverage was prepared by heating the water to 80° C. In this water the powder of Example 7 was dispersed with the help of a turrax blender, following which the solution was held for 10 minutes. The dispersion was cooled to 15-20° C. Next, a dry blend of sugar and sucralose was dispersed into the aqueous solution with the help of the turrax blender. Next, the fruit concentrate and sodium hexamethaphosphate were added. Finally, the citric acid was added to adjust the pH of the beverage to 3.8-4.3. The beverage product was sterilised in a tubular UHT system and subsequently homogenised at 220-230 bar. The product was filled in sterilised 1 litre glass bottles under aseptic conditions (laminar flow) and stored at 20° C.

After a storage period of 3 months, the product was evaluated using the techniques described in Example 6 for determining sediment redispersibility, for analysing the percentage of mineral in the sediment and for analysing the taste.

### Results

| | | % of total Ca | |
|---|---|---|---|
| sediment properties | | in sediment | panel result |
| <1 vol. % | mostly | <1 wt. % | preferred, slightly |
| | redispersible | | astringent and |
| | | | beany |

1. A method of producing an edible aqueous liquid composition that has been supplemented with at least 2 mmole calcium per litre, said method comprising the successive steps of:
a. providing an acidic aqueous liquid having a pH in the range of 1.0-5.0 and containing dissolved acid that is capable of forming a water-insoluble salt with calcium;
b. adding to the acidic aqueous liquid a solid water-insoluble calcium carbonate salt;
c. allowing the calcium carbonate to decarboxylate until all calcium is dissolved; and
d. stabilising the meta-stable solution against sedimentation of calcium salt by adding soy protein to said meta-stable solution and, if the pH of said meta-stable solution is less than 3.2, by increasing the pH of said solution to a pH of more than 3.2.

2. Method according to claim 1, wherein the edible aqueous liquid composition has been supplemented with at least 7 mmole calcium per litre.

3. Method according to claim 1, wherein the acidic aqueous liquid has a pH in the range of 1.4-3.5.

4. Method according to claim 1, wherein the acidic aqueous liquid contains at least 5 mmole/l of an acid selected from the group of citric acid, tartaric acid, malic acid, phosphoric acid and combinations thereof.

5. Method according to claim 1, wherein the acid is citric acid.

6. Method according to claim 1, wherein the solid water-insoluble calcium carbonate salt is added to the acidic aqueous liquid in an amount of at least 1 mmole/l.

7. Method according to claim 1, wherein the water-insoluble calcium carbonate salt is added to the acidic aqueous liquid in a molar amount that represents 10-150% of the molar amount of acid that is contained in said acidic aqueous liquid.

8. Method according to claim 1, wherein the soy protein is added to the meta-stable calcium solution in an amount of at least 1 g/l.

9. Method according to claim 8, wherein the soy protein is added in an amount of at least 3 g/l.

10. Method according claim 1, wherein the meta-stable calcium solution is characterised in that sedimentation of calcium salt will occur if the product is kept under quiescent conditions at a temperature of 20° C. for 24 hours.

11. Method according to claim 1, wherein at least 0.1 g/l of a polysaccharide selected from the group consisting of pectin, carrageenan, alginate, carboxymethyl cellulose, xanthan, gellan gum and combinations thereof is added to the meta-stable calcium solution.

12. Method according to claim 1, wherein the edible aqueous liquid composition will not form a calcium salt sediment when stored at 20° C. under quiescent conditions for at least 3 months.

13. Method according to claim 1, wherein the edible aqueous liquid composition is a soy drink having a pH of 3.2-8.0, a soy protein content of 1-50 g/l and a calcium content of 2-40 mmole/l.

14. A soy drink having a pH of 3.2-8.0, said soy drink comprising:
1-50 g/l of soy protein;
2-40 mmole/l of calcium;
1-60 mmole/l of an acid selected from the group consisting of citric acid, tartaric acid, malic acid, phosphoric acid and combinations thereof; and
at least 50 wt. % of water;
wherein the molar ratio of calcium to acid is within the range of 1:35 to 1.5:1 and wherein the soy drink is characterised in that it will not form a calcium salt sediment when stored at 20° C. under quiescent conditions for at least 3 months.

15. Soy drink according to claim 14, wherein the acid is citric acid.

16. Soy drink according to claim 14, wherein the soy drink contains at least 0.2 g/l of a polysaccharide selected from the group consisting of pectin, carrageenan, alginate, carboxymethyl cellulose, xanthan, gellan gum and combinations thereof.

17. Soy drink according to claim 14, wherein the soy drink has a pH in the range of 3.2-8.0.

18. A reconstitutable powder containing:
at least 0.04 mmole of calcium per gram of powder;
at least 0.02 mmole of acid per gram of powder, said acid being selected from the group consisting of citric acid, tartaric acid, malic acid, phosphoric acid and combinations thereof;
at least 20 mg of soy protein per gram of powder; and
less than 10 wt. % of water;
said reconstitutable powder further being characterised in that 25 grams of the powder can be reconstituted with 1 kg of water to yield an edible aqueous liquid that will not form a calcium salt sediment when stored at 20° C. under quiescent conditions for at least 3 months.

19. A reconstitutable powder according to claim 18, wherein the powder contains 0.1-1.0 mmole of citric acid per gram of powder.

20. Reconstitutable powder according to claim 18, wherein the powder contains 1-50 wt. % of a polysaccharide selected from the group consisting of pectin, carrageenan, alginate, carboxymethyl cellulose, xanthan, gellan gum and combinations thereof.

21. Reconstitutable powder according to claim 20, wherein the powder contains 2-10 wt. % of a polysaccharide selected from the group consisting of pectin, carrageenan, alginate, carboxymethyl cellulose, xanthan, gellan gum and combinations thereof

22. A method of preparing a reconstitutable powder that has been supplemented with calcium, said method comprising drying an edible aqueous liquid composition obtained by a method according to claim 1.

23. Method according to claim 22, wherein the drying of the edible aqueous liquid composition comprises spray drying.

24. (canceled)
